(19) United States
(12) Patent Application Publication
(10) Pub. No.: US 2009/0324908 A1
(43) Pub. Date: Dec. 31, 2009

(54) PLASTIC ARTICLE HAVING DECORATIVE PATTERN AND METHOD FOR MAKING THE PLASTIC ARTICLE

(75) Inventors: CHE-YUAN HSU, Shindian (TW); CHENG-WEN SU, Shindian (TW); GANG HUANG, Shenzhen City (CN); YAN-MIN WANG, Shenzhen City (CN); QIANG WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/486,879

(22) Filed: Jun. 18, 2009

(30) Foreign Application Priority Data
Jun. 30, 2008 (CN) 200810302443.0

(51) Int. Cl. B32B 3/10; B32B 27/00; B05D 3/12

(52) U.S. Cl. 428/205; 428/201; 264/132

(57) ABSTRACT

A plastic article having decorative pattern includes a film, a background coating and a substrate. The background coating is formed on the film, and the substrate combines with the background coating. The film has plural through holes defined therethrough, these plural through holes are filled with the material of the substrate to form the decorative pattern. The pattern and the background coating may present different colors. A method for making the plastic article is also described.

### BACKGROUND

1. Technical Field

The present disclosure relates to plastic articles, especially to a plastic article having decorative pattern and a method for making the plastic article.

2. Description of Related Art

In Molding Label (IML) process is now a typical method to produce decorative panels or plastic articles. The process is carried out by molding a plastic substrate into combination with a plastic film in a mould. Prior to the substrate being molded, a pattern is printed on the film, and the molded substrate is combined with the patterned film. Thereby, the pattern will not be abraded because it is between the film and the substrate. However, during the process of molding the substrate, the film is prone to melt because of the high temperature of the molten plastic infused into the mould to form the substrate. If the film melts, it is likely, the pattern printed on the film will become distorted.

Therefore, there is room for improvement within the art.

### BRIEF DESCRIPTION OF THE DRAWINGS

Many aspects of the plastic article having pattern can be better understood with reference to the following drawings. The components in the drawings are not necessarily drawn to scale, the emphasis instead being placed upon clearly illustrating the principles of the plastic article having pattern. Moreover, in the drawings like reference numerals designate corresponding parts throughout the several views.

FIG. 1 is a schematic view of a present embodiment of a plastic article having a decorative pattern.

FIG. 2 is a cross-sectional view of the plastic article having the pattern shown in FIG. 1 and taken approximately along line II-II of FIG. 1.

### DETAILED DESCRIPTION

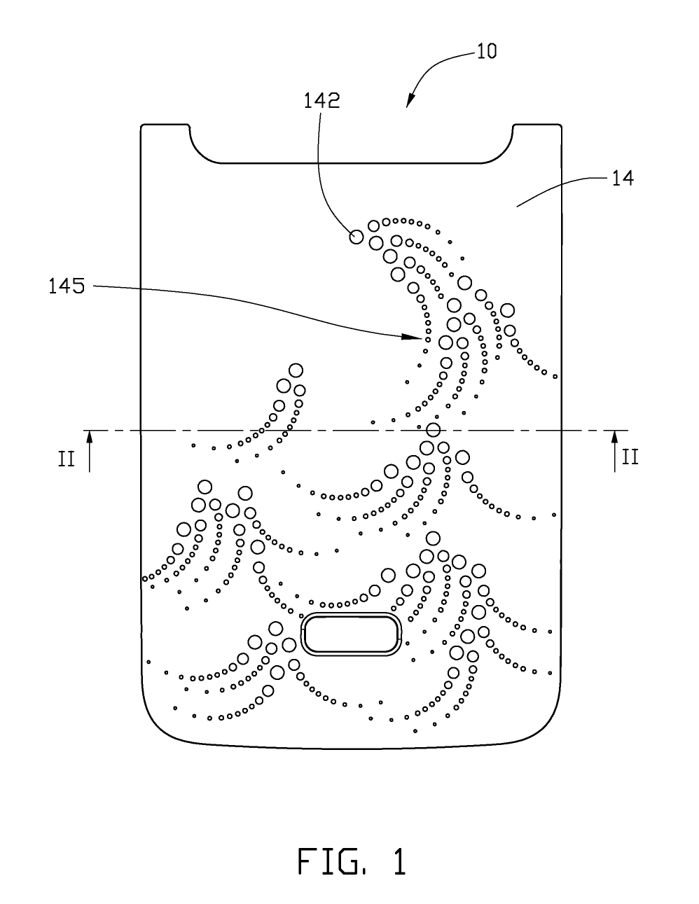

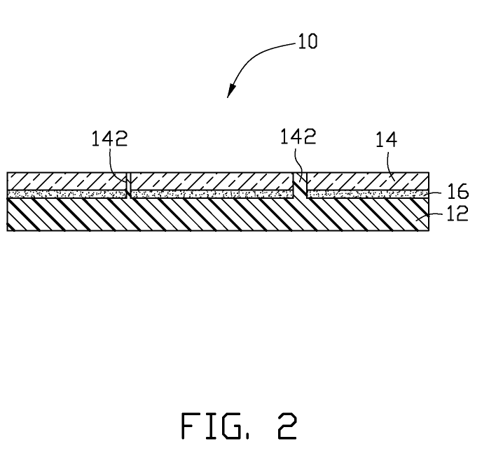

Referring to FIG. 1 and FIG. 2, in a present embodiment, a plastic article 10 includes a substrate 12, a film 14, and a background coating 16 formed between the substrate 12 and the film 14.

The substrate 12 is made of a molded plastic material. The substrate 12 typically presents only one color.

The film 14 is made of transparent or translucent plastic material. The film 14 has plural through holes 142 defined therethrough. These through holes 142 are filled with the material of the substrate 12 to define a desired pattern 145. The through holes 142 may have any shape. The size of each through holes 142 may be different.

The background coating 16 is formed on one surface of the film 14. The background coating 16 may be formed by ink printing, oil spray or physical vapor deposition. The background coating 16 presents another color which may be chosen according to the desired contrast with the color of the substrate 12. Therefore, the exemplary pattern 145 formed by filling the through holes 142 with the material of the substrate 12 may be, for example, in strong or subtle contrast to the background coating 16.

A method for making the plastic article 10 may include the following steps:

A film 14 is provided. The film 14 is made of transparent or translucent plastic material.

The film 14 is punched to form plural through holes 142 therethrough. The punching step may be carried out with a die. These through holes 142 may define a pattern 145.

A background coating 16 is formed on one surface of the film 14. The background coating 16 may be formed by ink printing, oil paint spray, or physical vapor deposition.

The film 14 having the background coating 16 is placed in a mould to mold a substrate 12. During the process of molding the substrate 12, the background coating 16 faces the hot sprue of the mould, molten plastic is infused through the hot sprue into the mould to form the substrate 12 on the background coating 16, and the through holes 142 are simultaneously filled with the molten plastic to form the pattern 145. The color of the substrate 12 may be chosen to contrast with the color of the background coating 16.

It should be understood, the background coating 16 can also define a pattern or texture which is different from the pattern 145 to enhance the appearance of the pattern 145.

It should be understood, the background coating 16 may be formed on the film 14 prior to forming the through holes 142.

The plastic article 10 prepared via the above method has a pattern 145 in the film 14. The pattern 145 is formed by filling the through holes 142 with the molding plastic in the process of molding the substrate 12. The pattern 145 and the substrate 12, may for example, present the same color, while the background coating 16 may present a different color from the pattern 145 and/or the substrate 12 to achieve a desired contrast or appearance.

It should be understood, however, that even though numerous characteristics and advantages of the present embodiments have been set forth in the foregoing description, together with details of functions of the embodiments, the disclosure is illustrative only, and changes may be made in detail within the principles of the invention to the full extent indicated by the broad general meaning of the terms in which the appended claims are expressed.

What is claimed is:

1. A plastic article having pattern, comprising:
a film, the film having plural through holes defined therethrough;
a background coating formed on the film; and
a substrate combined with the background coating;
wherein the through holes are filled with the material of the substrate to form a decorative pattern.

2. The plastic article as claimed in claim 1, wherein the background coating is an ink printed coating, an oil spray coating or a vacuum vapor deposition coating.

3. The plastic article as claimed in claim 1, wherein the film is made of transparent or translucent plastic material.

4. A method for making a plastic article, comprising:
providing a film;
defining plural through holes through the film;
forming a background coating on one surface of the film; and
molding a substrate on the background coating and into the through holes to form a decorative pattern.

5. The method as claimed in claim 4, wherein the through holes are punched with a die.

6. The method as claimed in claim 4, wherein the background coating is formed by ink printing, oil spray or vacuum vapor deposition.

7. The method as claimed in claim 4, wherein the background coating and the substrate may present different colors.

8. A method for making a plastic article, comprising:
providing a film;
forming a background coating on one surface of the film, the background coating presenting one color;
defining plural through holes through the film and the background coating; and
molding a substrate on the background coating and into the through holes to form a decorative pattern, the substrate presenting another color.
